(19) United States
(12) Patent Application Publication
(10) Pub. No.: US 2006/0141391 A1
(43) Pub. Date: Jun. 29, 2006

(54) Laser marking of documents of value

(76) Inventors: Sylke Klein, Rossdorf (DE); Michael Weiden, Darmstadt (DE); Wolfgang Kraas, Darmstadt (DE); Klaus-Christian Ullmann, Bensheim (DE); Burkhard Krietsch, Dieburg (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 11/289,769

(22) Filed: Nov. 30, 2005

(30) Foreign Application Priority Data
Nov. 30, 2004 (DE) 102004057918.0

(51) Int. Cl. G03C 1/76

(52) U.S. Cl. 430/270.1

(57) ABSTRACT

Disclosed are laser markings on a document of value and methods of preparing the same which are based on the interaction of the laser radiation with the printing-ink employed.

The invention relates to laser marking of documents of value which are based on the interaction of the laser radiation with the printing-ink systems employed.

Laser ablation processes have long been known to the person skilled in the art, in particular for papers of value, such as banknotes. These processes produce, for example, serial numbers in negative form through the complete removal of the applied printing ink, as described, for example, in DE-A 28 36 529. These processes offer security advantages since firstly numbering rollers having negative symbols are difficult to obtain and secondly the production of white numerals (presupposing the banknote paper is white) on multicolour-printed papers of value is difficult using conventional printing processes, as described, for example, in DE-A 28 36 529.

WO 98/03348 discloses the laser etching of the document of value itself, i.e. the local ablation of the document or even perforation in combination with bleaching and decolourisation phenomena of the printed areas.

Further security markings are, as described, for example, in WO 2004/009371 A1, possible through the laser-induced production of feelable (tactile) relief-like markings on documents of value with/without blackening or colour change of the correspondingly modified security paper.

However, the processes described in the prior art for the marking of documents of value have the disadvantage that only full-area and complete laser ablation which produces the marking is possible.

The object of the present invention was therefore to develop the counterfeiting- and copy-proof marking of documents of value using the laser technique which does not have the above-mentioned disadvantages.

Surprisingly, it has now been found that the laser marking of documents of value, if they have a specific printing-ink layer system, is possible through

1. selective colour removal of the printing inks and

2. production of a microinscription with/without tactility.

The laser technique itself offers advantages in marking since it is hardly available for counterfeits, owing to the high acquisition costs and the equipment complexity, and produces marks on documents of value which can only be copied with difficulty or not at all by conventional printing processes.

The present invention relates to the laser marking of documents of value which is distinguished by the fact that at least one printing ink or printing-ink layer system is applied to a substrate, where the printing ink or at least one layer in the printing-ink layer system comprises a laser-sensitive component, and the printing ink is selectively removed by means of a laser, and, if desired, microinscriptions/images are additionally produced in the selectively removed areas by means of the laser.

The process according to the invention enables documents of value, such as banknotes, bank and credit cards, cheques, cheque cards, securities, deeds, identity cards, stamps, certificates, identification cards, test certificates, rail and airline tickets, entry tickets, telephone cards, etc., to be marked in a counterfeiting- and copy-proof, permanent and encoded manner.

As shown in FIG. 1 in area labelled a), the action of suitable laser radiation on the printing-ink systems used in accordance with the invention results in selective removal of an ink layer, i.e. very finely graduated colour graduations from original hue to complete removal within the marking image are achieved. This can take place with the quasi-unlimited flexibility and individuality that are typical of the laser deflection method, i.e. for any graphical design, for alphanumeric symbols (letters, numbers, etc.), for randomly generated or continuously changing series numbers and codes (bar codes, data matrix codes, etc.).

Counterfeiting- and copy-proof markings are possible using specific security pigments and dyes. These are in the—to the human eye—visible region, for example, pigments having a pearlescent effect, multilayered interference pigments, optically variable pigments, or in the—to the human eye—invisible region (IR, UV region), corresponding colorants which can be removed selectively to completely or weakened or destroyed in their active colour centres or can be detected visually or under UV/IR light after removal of an uppermost other colour layer.

In addition, microinscriptions/images having inscription/image sizes below 500 μm and line thicknesses below 60 μm can be produced both in the selectively removed and also in the non-removed printed areas with the aid of a suitable laser as shown in FIG. 1 in the area labelled b).

This marking is carried out within the printed-on and/or already selectively ablated layer system by removal or decolourisation/carbonisation of the printing ink.

Depending on the printing inks and laser parameters used, the microinscriptions/images produced in this way can have tactility.

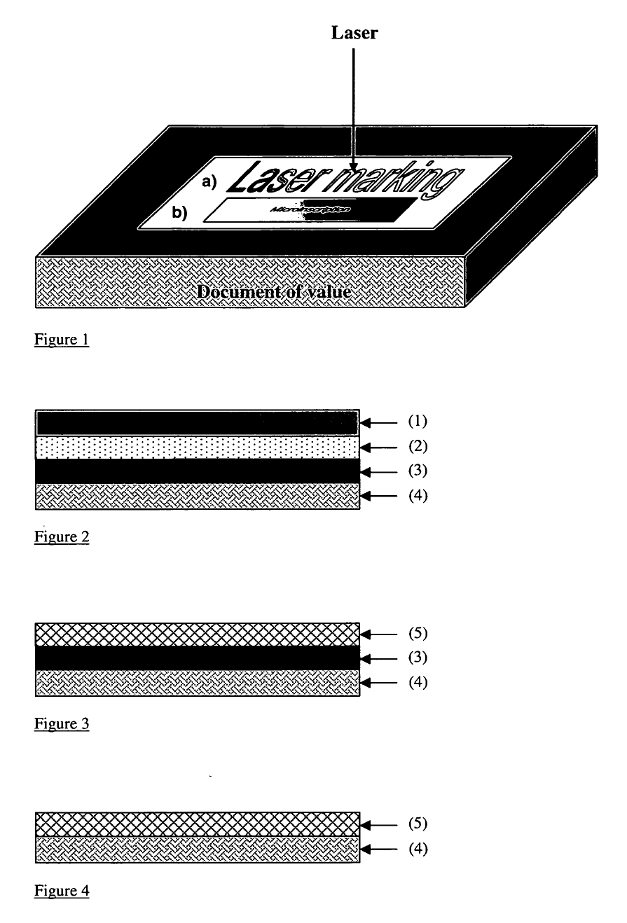

The printing-ink systems according to the invention can be printed onto various substrates (FIG. 2, layer (4)), such as, for example, paper, cardboard, board, plastics, plastic films and laminates, and subjected to laser marking. Particularly suitable for security applications are papers containing fibres from annual plants, such as cotton (for example cotton vellum paper) or cotton fibre blends or plastic fibres, which may have a single- or multilayered structure.

All plastics known to the person skilled in the art are suitable, in particular polyesters, polycarbonates, polyethylene, polypropylene, polyimides, polyacetals, polyamides, polyester esters, polyether esters, polyphenylene ethers, polyacetal, polybutylene terephthalate, polymethyl methacrylate, polyvinylacetal, polyvinyl chloride, polystyrene, acrylonitrile-butadiene-styrene (ABS), acrylonitrile-styrene-acrylate (ASA), polyether sulfones and polyether ketones, and copolymers and/or blends thereof.

For the printing-ink systems according to the invention, the layer systems and sequences depicted in FIGS. 2-4 have proven particularly suitable.

FIG. 2 shows a printing-ink system, applied to a document of value (4), consisting of a printing ink (1), a laser-sensitive layer (2) and a further printing ink (3). Layers (1) and (3) here may be identical or different.

In FIG. 3, only one further printing ink (5), which either absorbs the laser light itself or comprises the laser-sensitive component from layer (2), is applied to the printing ink (3).

FIG. 4 shows the printing ink (5) applied to a document of value.

The thickness of layers (1), (2), (3) and (5) is generally 1-15 μm, in particular 2-10 μm and very particularly preferably 4-8 μm, where the total thickness of all layers should not exceed 25 μm. The thickness of layers (1), (2), (3) and (5) here may be identical or different.

On corresponding exposure to a laser, printing ink (1) or (5) is removed in a finely graduated manner, i.e. selectively to completely, by the laser-sensitive component in layer (2) or (5).

The underlying printing-ink layer (3) or the document of value (4) correspondingly becomes finely graduated and/or becomes visible as a microinscription.

Furthermore, inherent absorption of the laser light by printing ink (5) enables blackening or lightening thereof to be achieved. This can be reinforced by the addition of a suitable polymer component, such as, for example, polyphenylene sulfide (PPS), which is intrinsically marking.

Whether layer (5) is removed or darkened/lightened is dependent on the laser parameters and the composition of ink in layer (5).

In the case of removal, the components of ink (5) like dye/pigment, binder or other additives evaporate/sublimate or ablate without any combustion residues. The laser parameters (laser energy) are typically corresponding (high). In the case of darkening/lightening the polymer component in the layer (5) is such that it is carbonized or foamed by the lazer.

The term “selectively removed” means that a printed color is ablated (removed) by laser beam in very fine steps. So a gradient of color depth, hue, shade, etc. is created going from one region to another where color is ablated to a different degree in each region by the laser beam.

FIG. 1 shows two examples, one labeled a) and one b). In a) every letter has a different “depth” of blue changing from dark blue via pale blue to white or another underlying color (blue is removed completely). The same is possible for a plane depicted in b) where from left to right the color changes from white to blue in a graduated manner and the plane contains a microinscription of a color (a graduated color) determined by the composition of the layers and the laser parameters.

The final design also depends on the layers under the color layer (1) or (5). That is, the color of the layer under color layer (1) or (5) determines what the color of the area will be where the color layer (1) or (5) is ablated selectively. The depth of the color removal of layer (1) or (5) at each location will determine how strongly the color of layer (1) or (5) appears and how strongly the color of the underlying layer will show through.

The following two cases further explain the concept above.

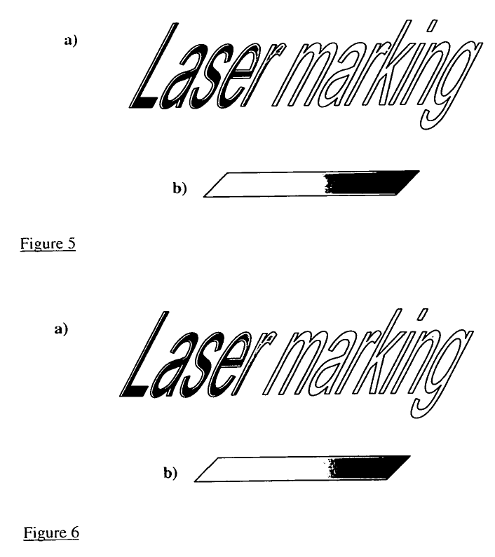

In case 1, which is illustrated in FIG. 5, the layer system is as illustrated in FIG. 4. Blue (in a black and white print, it is the darker color) is the only color in layer 5. The background of the ablated (removed) areas is the document of value itself, and is white in this case. As can be seen in a), the strength of the color blue goes from dark blue to lighter blue gradually with the progression from one letter to the next toward approaching the color of the underlying document and reaching it in the final letter, where complete ablation of the color blue is achieved. The same concept can be achieved in a single planar area depicted in b) where within the same area the strength of the color changes from the color of the document to light blue to dark blue gradually going from left to right.

In case 2, which is illustrated in FIG. 6, the layer system is as illustrated in FIG. 2 or 3. Blue (in a black and white print, it is the darker color) is in the top color layer as layer (5) in FIG. 3 or as layer (1) in FIG. 1. The color layer (3) is yellow (in a black and white print, this shows up as a grayish color) and it becomes more and more visible where more of the color blue from the top layer is ablated at a given point.

The principle of color removal is that the ink layer (1) or (5) is removed in different amounts at different locations by laser and as a result, a picture is achieved that at different locations has different amounts of ink remaining as described above. This can be realized by various laser parameters (power, speed, frequency, etc.).

Without wishing to be bound by theory, it is believed that the laser sensitive layer (2) reacts with the laser energy and causes the removal of the top layer (1). Whether layer (2) is removed completely does not matter to the observed image because of the transparency or colorlessness or low concentration of laser sensitive pigments.

Preferably, markings of this invention will have some areas of less than complete ink removed and/or less than complete ink retention. When complete removal does otherwise occur, there will at least be a microinscription present.

The printing inks are preferably applied by the following printing processes:

relief printing

gravure printing

flexographic printing

direct offset printing

indirect offset printing

pad printing

intaglio printing

screen printing

Furthermore, application of the ink by means of partial or full-area in-line or off-line lacquering is possible.

The printing ink (1) can be any colorant-containing printing ink, which is ideally transparent and/or translucent to the laser light in the stated wavelength range.

The printing ink (3) employed can be any conceivable printing ink for the printing of documents of value, in particular those having further security features since these are not exposed to radiation.

Suitable colorants are all those known to the person skilled in the art which do not decompose on laser irradiation and are photostable. The colorant can also be a mixture of two or more substances. The proportion of colorants in the printing ink is preferably between 5 and 35% by weight.

Suitable colorants are all organic and inorganic dyes and pigments known to the person skilled in the art. Particularly suitable are pigments having a pearlescent effect, multilayered interference pigments, optically variable pigments, UV dyes, azo pigments and dyes, such as, for example, monoazo pigments and dyes, diaryl pigments, isoindolines, benzimidazolones, bisazopyrazolones, beta-naphthols, naphthol AS pigments, disazo condensation pigments, BONS pigments, polycyclic pigments and dyes, such as, for example, triarylcarbonium pigments, perinones, perylenes, anthraquinones, flavanthrones, isoindolinones, pyranthrones, anthrapyrimidines, quinacridones, thioindigo, dioxazines, indanthronones, diketopyrrolopyrroles, quinonephthalones, metal-complexing pigments and dyes, such as, for example, beta-copper phthalocyanines, azomethine, dioxime and isoindolinone complexes, metal pigments, oxide and oxide hydroxide pigments, oxide mixed-phase pigments, metal-salt pigments, such as, for example, chromate and chromate-molybdate mixed-phase pigments, carbonate pigments, sulfide and sulfide-selenium pigments, complex-salt pigments and silicate pigments, as well as carbon black-based pigments.

Of the said colorants, particular preference is given to monoazo pigments, diaryl pigments, benzimidazolones, beta-naphthols, naphthol AS pigments, BONS pigments, triarylcarbonium pigments, beta-copper phthalocyanines, carbon blacks (Pigment Black 7), pearlescent and optically variable pigments, as well as metal pigments.

The laser-sensitive component used in layer (2) or in the laser light-absorbent printing ink (5) can be any material which absorbs the laser-light energy sufficiently in the stated wavelength range and converts it into heat energy.

The laser-sensitive components which are suitable for marking are preferably based on carbon, carbon black, graphite, metal oxides, such as, for example, Sn(Sb)O₂, TiO₂, anthracene, IR-absorbent colorants, such as, for example, perylenes/rylenes, pentaerythritol, copper hydroxide phosphates, molybdenum disulfides, antimony(III) oxide and bismuth oxychloride, flake-form, in particular transparent or semitransparent substrates made from, for example, phyllosilicates, such as, for example, synthetic or natural mica, talc, kaolin, glass flakes, SiO₂ flakes or synthetic support-free flakes. Furthermore suitable are also flake-form metal oxides, such as, for example, flake-form iron oxide, aluminium oxide, titanium dioxide, silicon dioxide, LCPs (liquid crystal polymers), holographic pigments, conductive pigments or coated graphite flakes.

The flake-form pigments employed can also be metal powders, which may be uncoated or also covered by one or more metal-oxide layers; preference is given, for example, to Al, Cu, Cr, Fe, Au, Ag and steel flakes. If corrosion-susceptible metal flakes, such as, for example, Al, Fe or steel flakes, are to be employed in uncoated form, they are preferably covered with a protective polymer layer.

Besides flake-form substrates, it is also possible to employ spherical pigments, for example made from Al, Cu, Cr, Fe, Au, Ag and/or Fe.

Particularly preferred substrates are mica flakes coated with one or more metal oxides. The metal oxides used here are both colourless, high-refractive-index metal oxides, such as, in particular, titanium dioxide, antimony (III) oxide, zinc oxide, tin oxide and/or zirconium dioxide, and also coloured metal oxides, such as, for example, chromium oxide, nickel oxide, copper oxide, cobalt oxide and in particular iron oxide (Fe₂O₃, Fe₃O₄). The laser-sensitive component used is particularly preferably antimony(III) oxide, alone or in combination with tin oxide.

These substrates are known and the majority are commercially available, for example under the brand Iriodin® Lazerflair from Merck KGaA, and/or can be prepared by standard methods known to the person skilled in the art. Pigments based on transparent or semitransparent flake-form substrates are described, for example, in the German patents and patent applications 14 67 468, 19 59 998, 20 09 566, 22 14 454, 22 15 191, 22 44 298, 23 13 331, 25 22 572, 31 37 808, 31 37 809, 31 51 343, 31 51 354, 31 51 355, 32 11 602, 32 35 017, 38 42 330, 44 41 223. Coated SiO₂ flakes are known, for example, from WO 93/08237 (wet-chemical coating) and DE-A 196 14 637 (CVD process).

Multilayered pigments based on phyllosilicates are known, for example, from DE-A 196 18 569, DE-A 196 38 708, DE-A 197 07 806 and DE-A 198 03 550. Particularly suitable are multilayered pigments having the following structure:

mica+TiO₂+SiO₂+TiO₂

mica+TiO₂+SiO₂+TiO₂/Fe₂O₃

mica+TiO₂+SiO₂+(Sn, Sb)O₂

SiO₂ flake+TiO₂+SiO₂+TiO₂

Particularly preferred laser light-absorbent substances are anthracene, perylenes/rylenes, such as, for example, ter- or quaterrylenetetracarboxy-diimides), pentaerythritol, copper hydroxide phosphates, molybdenum disulfide, antimony(III) oxide, bismuth oxychloride, carbon, antimony, Sn(Sb)O₂, TiO₂, silicates, SiO₂ flakes, metal oxide-coated mica and/or SiO₂ flakes, conductive pigments, sulfides, phosphates, BiOCl, or mixtures thereof.

The laser-sensitive component can also be a mixture of two or more components and is present to the extent of 0.5-40% by weight, based on the total weight of the liquid printing ink.

Suitable binders for the layer systems are, for example:

a) for aqueous systems:

acrylates, methacrylates, polyesters, polyurethanes, polyvinyl alcohols, polyvinylpyrrolidones, and copolymers of the said substances
   b) for solvent-based systems:
nitrocellulose, ethylcellulose, polyamides, PVC-PVA copolymers, polyvinylbutyrals, polyisobutylene, chlorinated rubber, colophony-modified phenolic resins, maleic resins, calcium/zinc resinates, EHEC, acrylates and copolymers of the said substances
   c) radiation-curing (UV, EB) systems:
epoxy acrylates, polyurethane acrylates, polyester acrylates, polyether acrylates
   d) oil-based systems:
colophony-modified phenolic resins, maleic acid-modified phenolic resins, alkyd resins (for example linseed oil alkyd resin), hydrocarbon resins.

The binder content is 10-50% by weight, based on the total weight of the liquid system.

Suitable solvents and cosolvents for the layer systems are, for example:

a) for aqueous systems:

water, water/alcohol mixtures
   b) for solvent-containing systems:
ethyl alcohol, isopropyl alcohol, n-propyl alcohol, acetone, ethyl acetate, isopropyl acetate, n-propyl acetate, methoxypropanol, ethoxypropanol, toluene, aliphatic hydrocarbons, and mixtures of the said solvents
   c) for radiation-curing systems (reactive diluents):
hexanediol diacrylate, di/tripropylene glycol diacrylate, trimethylpropane triacrylate, trimethylolpropane ethoxytriarylate
   d) for oil-based systems:
mineral oils, vegetable oils and mixtures of the two classes of substance.

The solvent content is 30 to 70% by weight, based on the liquid system.

The ablation is carried out using a suitable laser, preferably by the beam deflection method, or using a suitable mask by the mask method.

The laser used generally has a wavelength in the range from 157 nm to 10.6 μm, preferably in the range from 532 nm to 10.6 μm. Particular preference is given to the use of Nd:YAG and YVO₄ lasers (1064 and 532 nm respectively), diode lasers (808-980 nm) and CO₂ lasers (10.6 μm). However, the desired results can also be achieved using other conventional types of laser which have a wavelength in a region of high absorption of the laser light-absorbent substance used.

The ablation to be produced or the microinscription is determined by the irradiation time (or number of pulses in the case of pulsed lasers) and irradiation power of the laser (pulse power density in the case of pulsed lasers) and of the layer system used.

The parameters of the laser used depend on the particular application and can readily be determined by the person skilled in the art in the individual case.

Preference is given to the use of a YAG laser, YVO₄ laser, diode laser or CO₂ laser in various laser wavelengths, 1064 nm, 808-980 nm or 10.6 μm. Marking is possible both in continuous (cw) and pulsed operation. The suitable power spectrum of the marking laser covers 2 to 300 watts, and the pulse frequency is in the range from 1 to 200 kHz.

The laser marking according to the invention can be employed in all cases where documents of value are to be marked individually and flexibly as well as in an encoded manner.

These include documents of value, such as banknotes, cheques, securities, deeds, identity cards, stamps, certificates, test certificates, entry tickets, rail and airline tickets, which are based on paper; cheque cards, identification cards, telephone cards, bank and credit cards, etc., which consist of suitable paper or plastic, and also laminates or other multilayered structures comprising plastic and paper.

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

In the foregoing and in the examples, all temperatures are set forth uncorrected in degrees Celsius and, all parts and percentages are by weight, unless otherwise indicated.

### EXAMPLES

### Example 1

### Preparation of a printing ink (1, 3)

Solvent-containing gravure printing

25 g of Colorcode® Turquoise-Lilac (security pigment from Merck KGaA)
75 g of nitrocellulose/alcohol extender

The pigment is stirred into the binder system while avoiding high shear forces. The printing viscosity is subsequently set (DIN 4 cup (DIN 53211) 14-25 s).

35 g of ethoxypropanol are added to 65 g of printing-ink concentrate (see above).

The ink is printed by gravure printing using a suitable gravure screen (for example 60 lines/cm, electronically engraved) on a suitable printing machine (for example Moser Rototest). The layer thickness is 4-8 μm.

### Example 2

### Production of a Laser-Sensitive Layer (2)

18.5 g of ethyl acetate
   1.5 g of PVB (polyvinylbutyral, Pioloform®, Wacker-Chemie)
   3-5 g of Sn(Sb)O₂ (d₅₀ value<1.1 μm) (Du Pont)

Polyvinylbutyral is dissolved in the initially introduced solvent ethyl acetate and stirred well. The laser-sensitive component Sn(Sb)O₂ is subsequently stirred in, and a homogeneous ink is prepared.

The ink is printed by gravure printing as described in Example 1.

### Example 3

### Production of a Laser-Sensitive Layer (2)

18.5 g of ethyl acetate
   1.5 g of PVB (polyvinylbutyral, Polioform®, Wacker-Chemie)
   2.0 g of gas black (d₅₀ value<17 nm) (Special Black 6 from Degussa)

The processing is carried out as in Working Example 2. The laser-sensitive component employed is gas black.

The ink is printed by gravure printing as described in Example 1.

### Example 4

### Production of a Laser-Sensitive Layer (2)

20 g of Masterblend 50 (SICPA-MRBERG AG)
15 g of Iriodin® Lazerflair 825 (pigment from Merck KGaA)
10 g of ethyl acetate/ethanol (1:1)

The laser light absorber Iriodin® Lazerflair 825 is incorporated into the Masterblend 50 under gentle conditions and printed by gravure printing onto a paper which is suitable for the printing of securities. The desired viscosity can be set using the solvent mixture ethyl acetate/ethanol (DIN 4 cup (DIN 53211) 14-25 s). The application rate is 0.5-1 g/cm². The layer thickness is 4-8 μm.

### Example 5

### Production of a laser-sensitive layer (2)

45-47.5 g of Weilburger Senolit HGL
2.5-5.0 g of Budit 322 (Cu hydroxide phosphate from Budenheim)

The laser-sensitive Budit 322 is incorporated in powder form into the print medium and printed by gravure printing onto a paper which is suitable for the printing of securities. The application rate is 0.5-1 g/cm². The layer thickness is 4-8 μm.

### Example 6

### Production of a Laser-Sensitive Layer (2)

45-47.5 g of Weilburger Senolit HGL
2.5-5.0 g of Colorcode® LM (particle size<5 μm) (Merck KGaA)

The laser light absorber Colorcode® LM is incorporated into the Weilburger Senolit under gentle conditions and printed by gravure printing onto a paper which is suitable for the printing of securities. The application rate is 0.5-1 g/cm². The layer thickness is 4-8 μm.

### Example 7

### Preparation of a Laser-Sensitive Printing Ink (5)

Aqueous Screen Printing

9.75 g of Colorcrypt® Red-Gold (security pigment from Merck KGaA)
0.75 g of Sandospers Yellow WF 013 (pigment concentration 38%, Clariant)
   5 g of Colorcode® LM (particle size<5 μm) (Merck KGaA)
   87.5 g of Helizarin MT 92 (BASF)

The pigments and pigment composition are stirred into the binder system while avoiding high shear forces. The printing is carried out by flat-bed screen printing using an 80T screen with monofilament screen fabric. The viscosity of the printing ink is between 2-10 Pa·s. The layer thickness is 8-20 μm.

### Example 8

### Production of a Selectively Ablated Inscription with Microinscription Inside

A printing ink (5) comprising Iriodin®123 (TiO₂/mica pigment from Merck KGaA) as pigment and nitrocellulose as binder and PVC powder (for example Solvin 072GA, Solvay) or PA powder (Vestosint 2070, Degussa) is applied by screen printing to a paper which is suitable for the printing of securities and lasered using an Nd vanadate laser (1064 nm). In order to produce the selectively ablated letter sequence, the laser power of an Nd vanadate laser is varied from 30 to 80% in 10% steps at a rate of 500 mm/s and a frequency of 40 to 60 kHz in pulsed operation.

A further marking by a microinscription is incorporated into this marking. Microinscriptions with an inscription height of less than 500 μm and line thicknesses of 40 μm are achieved with a laser power of 80% at 500 mm/s and 40 kHz.

The entire disclosures of all applications, patents and publications, cited herein and of corresponding German application No. 102004057918.0, filed Nov. 30, 2004 are incorporated by reference herein.

The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

1. A laser marking on a document of value, comprising at least one printing ink or printing-ink layer on a substrate, where the at least one printing ink or printing-ink layer comprises a laser-sensitive component, and wherein printing ink in at least one area of the at least one printing ink or printing ink layer is selectively removed by a laser, and optionally a microinscription/image is produced by the laser in a selectively removed area, and in the case where otherwise there would be complete removal of the printing ink from the marking, said microinscription/image is produced in the marking.

2. A laser marking on a document of value according to claim 1, wherein the substrate is paper, cardboard, board, plastic, plastic film or laminate.

3. A laser marking on a document of value according to claim 1, wherein the at least one printing-ink layer has two or three layers.

4. A laser marking on a document of value according to claim 1, wherein the at least one printing ink layer comprises the following three layers: printing ink—laser-sensitive component—printing ink.

5. A laser marking on a document of value according to claim 1, wherein the at least one printing ink layer comprises two layers of printing ink, which may be identical or different, where one printing-ink layer comprises the laser-sensitive component.

6. A laser marking on a document of value according to claim 1, wherein the laser-sensitive component is carbon, carbon black, graphite, Sn(Sb)O₂, TiO₂, anthracene, an IR-absorbent colorant, pentaerythritol, a copper hydroxide phosphate, a molybdenum disulfide, antimony(III) oxide, bismuth oxychloride, a phyllosilicate, natural or synthetic mica, metal oxide-coated flakes of mica, glass or SiO₂, talc, kaolin, glass flakes, SiO₂ flakes, flake-form iron oxide, aluminium oxide, titanium dioxide, silicon dioxide, LCPs (liquid crystal polymers), holographic pigments, conductive pigments, coated graphite flakes or a mixture thereof.

7. A laser marking on a document of value according to claim 1, wherein the at least one printing ink or printing ink layer comprises security pigments.

8. A laser marking on a document of value according to claim 7, wherein the security pigments are optically variable pigments, pearlescent pigments, interference pigments, goniochromatic lustre pigments, multilayered pigments or a mixture thereof.

9. A laser marking on a document of value according to claim 1, wherein the at least one printing ink or printing ink layer comprises one or more colorants.

10. A laser marking on a document of value according to claim 1, wherein the laser used for selectively removing areas of the at least one printing ink or printing ink layer is an Nd:YAG, Nd:YVO₄, diode or CO₂ laser.

11. A method for preparing a laser marking on a document of value, complying applying to a substrate at least one printing ink or printing-ink layer, where the at least one printing ink or printing-ink layer comprises a laser-sensitive component, and selectively removing ink by a laser in at least one area of the at least one printing ink or printing-ink layer, and optionally a microinscription/image is additionally produced by the laser in a selectively removed area, and in the case where otherwise there would be complete removal of the printing ink from the marking, said microinscription/image is produced in the marking.

12. A method according to claim 1, wherein the substrate is paper, cardboard, board, plastic, plastic film or laminate.

13. A method according to claim 1, wherein the at least one printing-ink layer has two or three layers.

14. A method according to claim 1, wherein the at least one printing ink layer comprises the following three layers: printing ink—laser-sensitive component—printing ink.

15. A method according to claim 1, wherein the at least one printing ink layer comprises two layers of printing ink, which may be identical or different, where one printing-ink layer comprises the laser-sensitive component.

16. A method according to claim 1, wherein the laser-sensitive component is carbon, carbon black, graphite, Sn(Sb)O₂, TiO₂, anthracene, an IR-absorbent colorant, pentaerythritol, a copper hydroxide phosphate, a molybdenum disulfide, antimony(III) oxide, bismuth oxychloride, a phyllosilicate, natural or synthetic mica, metal oxide-coated flakes of mica, glass or SiO₂, talc, kaolin, glass flakes, SiO₂ flakes, flake-form iron oxide, aluminium oxide, titanium dioxide, silicon dioxide, LCPs (liquid crystal polymers), holographic pigments, conductive pigments, coated graphite flakes or a mixture thereof.

17. A method according to claim 1, wherein the at least one printing ink or printing ink layer comprises security pigments.

18. A method according to claim 17, wherein the security pigments are optically variable pigments, pearlescent pigments, interference pigments, goniochromatic lustre pigments, multilayered pigments or a mixture thereof.

19. A method according to claim 1, wherein the at least one printing ink or printing ink layer comprises one or more colorants.

20. A method according to claim 1, wherein the laser used for selectively removing areas of the at least one printing ink or printing ink layer is an Nd:YAG, Nd:YVO₄, diode or CO₂ laser.
